(19) United States
(12) Patent Application Publication
(10) Pub. No.: US 2020/0111061 A1
(43) Pub. Date: Apr. 9, 2020

(54) Apparatus and Method for Combined Visual Intelligence

(71) Applicant: Solera Holdings, Inc., Westlake, TX (US)

(72) Inventors: Pascal Stucki, Zurich (CH); Nima Nafisi, Wadenswil (CH); Pascal De Buren, Zurich (CH); Maurice Gonzenbach, Zurich (CH)

(21) Appl. No.: 16/590,574

(22) Filed: Oct. 2, 2019

Related U.S. Application Data
(60) Provisional application No. 62/740,784, filed on Oct. 3, 2018.

(51) Int. Cl. G06Q 10/00; G06F 16/55; G06Q 30/02

(52) U.S. Cl. CPC G06Q 10/20; G06N 20/00; G06Q 30/0283; G06F 16/55

(57) ABSTRACT

A method includes accessing a plurality of input images of a vehicle and categorizing each of the plurality of images into one of a plurality of categories. The method also includes determining one or more parts of the vehicle in each categorized image, determining a side of the vehicle in each categorized image, and determining a first list of damaged parts of the vehicle. The method also includes determining, using the categorized images, an identification of the vehicle; determining, using the plurality of input images, a second list of damaged parts of the vehicle; and aggregating, using one or more rules, the first and second lists of damaged parts of the vehicle in order to generate an aggregated list of damaged parts of the vehicle. The method also includes displaying a repair cost estimation for the vehicle.

### PRIORITY

This application claims the benefit, under 35 U.S.C. § 119(e), of U.S. Provisional Patent Application No. 62/740,784 filed 3 Oct. 2018, which is incorporated herein by reference in its entirety.

### TECHNICAL FIELD

The disclosure generally relates generally to image processing, and more particularly to an apparatus and method for combined visual intelligence.

### BACKGROUND

Components of vehicles such as automobile body parts are often damaged and need to be repaired or replaced. For example, exterior panels of an automobile or a recreational vehicle (RV) may be damaged in a driving accident. As another example, the hood and roof of an automobile may be damaged by severe weather (e.g., hail, falling tree limbs, and the like). Typically, an appraiser is tasked with inspecting a damaged vehicle in connection with an insurance claim and providing an estimate to the driver and insurance company.

### SUMMARY OF PARTICULAR EMBODIMENTS

In some embodiments, a method includes accessing a plurality of input images of a vehicle and categorizing each of the plurality of images into one of a plurality of categories. The method also includes determining one or more parts of the vehicle in each categorized image, determining a side of the vehicle in each categorized image, and determining a first list of damaged parts of the vehicle. The method also includes determining, using the categorized images, an identification of the vehicle; determining, using the plurality of input images, a second list of damaged parts of the vehicle; and aggregating, using one or more rules, the first and second lists of damaged parts of the vehicle in order to generate an aggregated list of damaged parts of the vehicle. The method also includes displaying a repair cost estimation for the vehicle.

The disclosed embodiments provide numerous technical advantages. For example, a detailed blueprint of repairs to a vehicle (e.g., costs, times to repair, etc.) may be automatically provided based on one or more images of a vehicle. This may improve the efficiency of providing a vehicle repair estimate by not requiring a human assessor to physically assess a damaged vehicle. Additionally, by automatically providing a repair estimate using images, resources such as paper, electricity, and gasoline may be conserved. Other technical features may be readily apparent to person having ordinary skill in the art (PHOSITA) from the following figures, descriptions, and claims.

The included figures, and the various embodiments used to describe the principles of the figures, are by way of illustration only and should not be construed in any way to limit the scope of the disclosure. A PHOSITA will understand that the principles of the disclosure may be implemented in any type of suitably arranged device, system, method, or computer-readable medium.

### BRIEF DESCRIPTION OF THE DRAWINGS

For a more complete understanding of this disclosure and its features, reference is now made to the following description, taken in conjunction with the accompanying drawings, in which:

FIG. 1 is a system diagram for providing combined visual intelligence, according to certain embodiments.

FIG. 2 is a diagram illustrating a visual intelligence engine that may be utilized by the system of FIG. 1, according to certain embodiments.

FIG. 3 illustrates a graphical user interface for providing an output of the system of FIG. 1, according to certain embodiments.

FIG. 4 illustrates a method for providing combined visual intelligence, according to certain embodiments.

FIG. 5 is an exemplary computer system that may be used by or to implement the methods and systems disclosed herein.

### DESCRIPTION OF EXAMPLE EMBODIMENTS

Components of vehicles such as automobile body parts are often damaged and need to be repaired or replaced. For example, exterior panels (e.g., fenders, etc.) of an automobile or a recreational vehicle (RV) may be damaged in a driving accident. As another example, the hood and roof of an automobile may be damaged by severe weather (e.g., hail, falling tree limbs, and the like).

Typically, an appraiser is tasked with inspecting a damaged vehicle in connection with an insurance claim and providing an estimate to the driver and insurance company. Manually inspecting vehicles, however, is time consuming, costly, and inefficient. For example, after a severe weather event occurs in a community, it can take days, weeks, or even months before all damaged vehicles are inspected by approved appraisers. However, because drivers typically desire an estimate to repair or replace damaged vehicle components to be provided in a timely manner, such long response times can cause frustration and dissatisfaction for drivers whose automobiles were damaged by the weather event.

The teachings of the disclosure recognize that it is desirable to provide estimates to repair or replace damaged vehicle components in a timely and user-friendly manner. The following describes systems and methods of combined visual intelligence for providing these and other desired features.

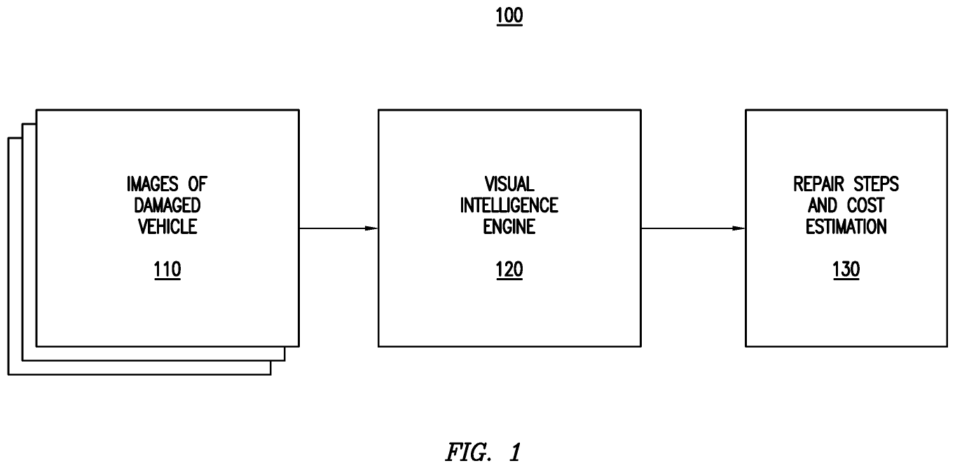

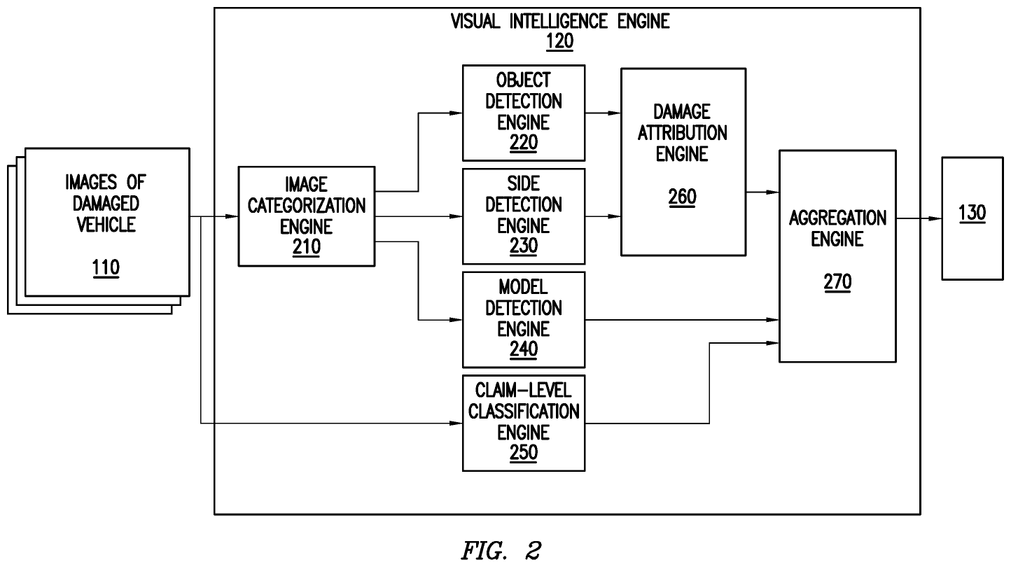

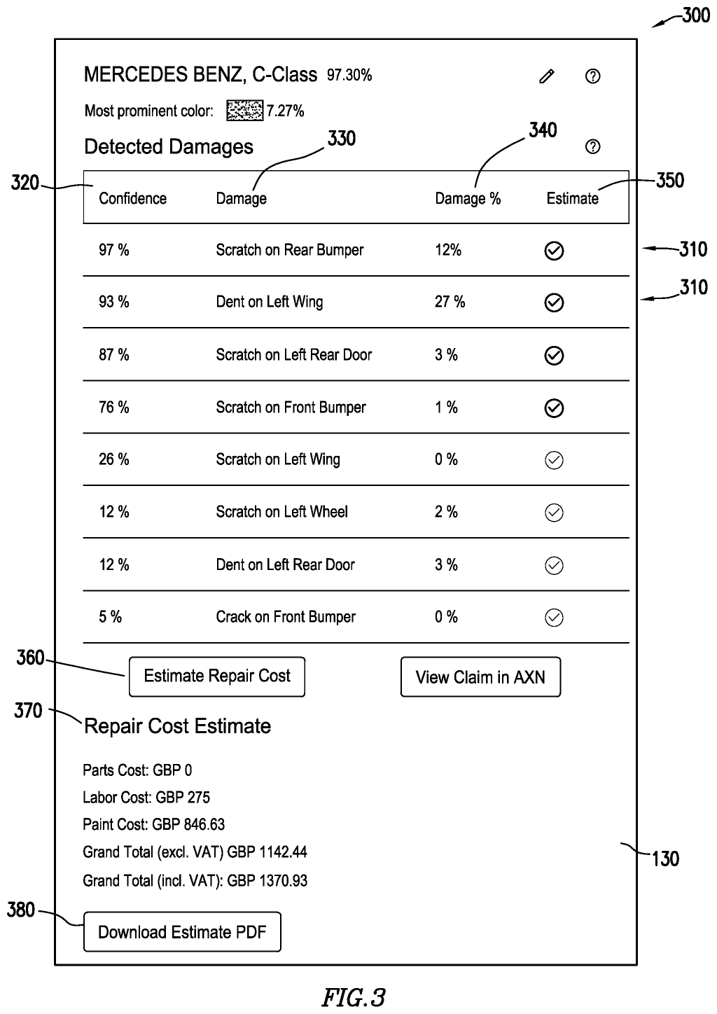

FIG. 1 illustrates a repair and cost estimation system 100 for providing combined visual intelligence, according to certain embodiments. In some embodiments, repair and cost estimation system 100 includes multiple damaged vehicle images 110, a visual intelligence engine 120, and repair steps and cost estimation 130. In general, damaged vehicle images 110 are input into visual intelligence engine 120. For example, any appropriate computing system (e.g., a personal computing device such as a smartphone, table computer, or laptop computer) may be used to capture damaged vehicle images 110. Visual intelligence engine 120 may access damaged vehicle images 110 (e.g., via local computer storage or remote computer storage via a communications link), process damaged vehicle images 110, and provide repair steps and cost estimation 130. As a result, estimates to repair or replace damaged vehicle components may be automatically provided in a timely and user-friendly manner without the need for a manual inspection/appraisal. An example of visual intelligence engine 120 is discussed in more detail below in reference to FIG. 2, and an example of repair steps and cost estimation 130 is discussed in more detail below in reference to FIG. 3.

FIG. 2 is a diagram illustrating a visual intelligence engine 120 that may be utilized by repair and cost estimation system 100 of FIG. 1, according to certain embodiments. In some embodiments, visual intelligence engine 120 includes an image categorization engine 210, an object detection engine 220, a side detection engine 230, a model detection engine 240, a claim-level classification engine 250, a damage attribution engine 260, and an aggregation engine 270. Visual intelligence engine 120 may be implemented by an appropriate computer-readable medium or computing system such as computer system 500.

In general, visual intelligence engine 120 analyzes damaged vehicle images 110 and outputs repair steps and cost estimation 130. For example, a driver of a vehicle may utilize their personal computing device (e.g., smartphone) to capture damaged vehicle images 110. An application running on their personal computing device (or any other appropriate computing device) may then analyze damaged vehicle images 110 in order to provide repair steps and cost estimation 130. As a result, estimates to repair or replace damaged vehicle components may be automatically provided in a timely and user-friendly manner without the need for a manual inspection/appraisal. The various components of certain embodiments of visual intelligence engine 120 are discussed in more detail below.

In some embodiments, visual intelligence engine 120 includes image categorization engine 210. In general, image categorization engine 210 utilizes any appropriate image classification method or technique to classify each image of damaged vehicle images 110. For example, each image of damaged vehicle images 110 may be assigned to one or more categories such as a full-view vehicle image or a close-up vehicle image. In this example, a full-view vehicle image may be an image where a full vehicle (e.g., a full automobile) is visible in the damaged vehicle image 110, and a close-up vehicle image may be an image where only a small portion of a vehicle (e.g., a door of an automobile but not the entire automobile) is visible in the damaged vehicle image 110. In other embodiments, any other appropriate categories may be used by image categorization engine 210 (e.g., odometer image, vehicle identification number (VIN) image, interior image, and the like). In some embodiments, image categorization engine 210 filters out images from damaged vehicle images 110 that do not show a vehicle or a non-supported body style. As used herein, a “vehicle” may refer to any appropriate vehicle (e.g., an automobile, an RV, a truck, a motorcycle, and the like), and is not limited to automobiles.

In some embodiments, visual intelligence engine 120 includes object detection engine 220. In general, object detection engine 220 identifies and localizes the area of parts and damages on damaged vehicle image 110 using instance segmentation. For example, some embodiments of object detection engine 220 utilize instance segmentation to identify a door, a hood, a fender, or any other appropriate part/area of damaged vehicle images 110. In some embodiments, object detection engine 220 analyzes images from image categorization engine 210 that have been categorized as a full-view vehicle image or a close-up vehicle image. The identified areas of parts/damages on damaged vehicle images 110 are output from object detection engine 220 to damage attribution engine 260, which is discussed in more detail below.

In some embodiments, visual intelligence engine 120 includes side detection engine 230. In general, side detection engine 230 utilizes any appropriate image classification technique or method to identify from which side of an automobile each image of damaged vehicle images 110 was taken. For example, side detection engine 230 identifies that each image of damaged vehicle images 110 was taken from either the left, right, front, or back side of the vehicle. In some embodiments, side detection engine 230 analyzes images from image categorization engine 210 that have been categorized as a full-view vehicle image or a close-up vehicle image. The identified sides of damaged vehicle images 110 are output from side detection engine 230 to damage attribution engine 260, which is discussed in more detail below.

In some embodiments, visual intelligence engine 120 includes model detection engine 240. In general, model detection engine 240 utilizes any appropriate multi-image classification technique or method to identify the manufacturer and model of the vehicle in damaged vehicle images 110. For example, model detection engine 240 analyzes damaged vehicle images 110 to determine that damaged vehicle images 110 correspond to a particular make and model of an automobile. In some embodiments, model detection engine 240 only analyzes images from image categorization engine 210 that have been categorized as a full-view vehicle image. In some embodiments, damaged vehicle images 110 may include an image of an automobile's VIN. In this example, model detection engine 240 may determine the VIN from the image and then access a database of information in order to cross-reference the determined VIN with the stored information. The identified manufacturer and model of the vehicle in damaged vehicle images 110 are output from model detection engine 240 to aggregation engine 270, which is discussed in more detail below.

In some embodiments, visual intelligence engine 120 includes claim-level classification engine 250. In general, claim-level classification engine 250 utilizes any appropriate multi-image classification technique or method to identify damaged components/parts of damaged vehicle images 110. For example, claim-level classification engine 250 analyzes one or more (or all) of damaged vehicle images 110 to determine that a hood of an automobile is damaged. As another example, claim-level classification engine 250 analyzes damaged vehicle images 110 to determine that a fender of a truck is damaged. In some embodiments, claim-level classification engine 250 identifies each damage type and location using semantic segmentation or any other appropriate method (e.g., use photo detection technology such as Google's Tensorflow technology to detect main body panels from photos). This may include: a) collecting multiple (e.g., 1000s) of photos of damaged vehicle, b) manually labelling/outlining the visible panels and damages on the photos, and c) training panel and damage detection using a technology such as Tensorflow. The identified components/parts of from claim-level classification engine 250 are output from claim-level classification engine 250 to aggregation engine 270, which is discussed in more detail below.

In some embodiments, visual intelligence engine 120 includes damage attribution engine 260. In general, damage attribution engine 260 uses outputs from object detection engine 220 (e.g., localized parts and damages) and side detection engine 230 (e.g., left or right side) to establish a list of damaged parts of a vehicle. In some embodiments, each item in the list of damaged parts may include an item identifier (e.g., door) and the side of the vehicle that the item is located (e.g., front, back, right, left). For example, using identified areas of parts/damages on damaged vehicle images 110 from object detection engine 220 and the identified sides of damaged vehicle images 110 from object detection engine 220, damage attribution engine 260 may create a list of damaged parts such as: front bumper, left rear door, right wing, etc. The list of damaged parts from damage attribution engine 260 are output from damage attribution engine 260 to aggregation engine 270.

In some embodiments, visual intelligence engine 120 includes aggregation engine 270. In general, aggregation engine 270 aggregates the outputs of damage attribution engine 260, model detection engine 240, and claim-level classification engine 250 to generate a list of damaged parts for the whole set of damaged vehicle images 110. In some embodiments, aggregation engine 270 uses stored rules (e.g., either locally-stored rules or rules stored on a remote computing system) to aggregate the results from damage attribution engine 260, model detection engine 240, and claim-level classification engine 250 to generate a list of damaged parts. In some embodiments, the rules utilized by aggregation engine 270 may include rules such as: 1) how to handle different confidence levels for a particular damage, 2) what to do if one model detects damage but another does not, and 3) how to handle impossible scenarios such as damage detected on front and rear bumper on same the same image. In other embodiments, aggregation engine 270 uses a machine learning model trained on historical claim data.

In some embodiments, aggregation engine 270 utilizes repair action logic in order to determine and visually display a repair action. In some embodiments, the repair logic is based on historical claim damages and analysis by expert assessors and repairers. In some embodiments, country-specific rules may be defined about how damages should be repaired. In some embodiments, the repair logic may depend on the vehicle model, damage type, panel, panel material, damage size, and location. In some embodiments, the repair logic includes the required preparation work (e.g., paint mixing, removing of parts to get access to the damage, clean up glass splitters etc), the actual repair and paint work including underlying part (e.g., not visible parts) on the photo (e.g., sensors under the bumper), and clean-up work (e.g., refitting the parts, recalibrations, etc.).

In some embodiments, aggregation engine 270 uses historical repairs data to determine repair actions and potential non-surface damage. In some embodiments, aggregation engine 270 searches for historical claims with the same vehicle, the same damaged components, and the same severity in order to identify the most common repair methods for such damages. In some embodiments, aggregation engine 270 may also search for historical claims with the same vehicle, the same damaged panels, and the same severity in order to detect additional repair work that might not be visible from damaged vehicle images 110 (e.g., replace sensors below a damaged bumper).

In some embodiments, aggregation engine 270 calculates an opinion time. In general, this step involves calculating the time the repairer will spend to fix the damage based on the detected damage size and severity. In some embodiments, the opinion time is calculated using stored data (e.g., stat tables) for repair action input. In some embodiments, data per model and panel about standard repair times may be used to calculate the opinion time. In some embodiments, formulas may be used to calculate the repair time based on the damage size and severity.

In some embodiments, repair and cost estimation system 100 uses the output of aggregation engine 270 and in some embodiments, client preferences, to generate and provide repair steps and cost estimation 130 (e.g., part costs, labor costs, paint costs, other work and costs such as taxes, etc.). In some embodiments, a predetermined calculation is run against the detected damages in order to generate the detailed repair estimate. In some embodiments, the client preferences may include rules about how to repair damages in different countries. Some examples may include: in some countries local laws and regulations must be followed (e.g. up to which size are you allowed to paint over small scratches); some insurances have rules that repair shops must follow (e.g. which repairs are allowed to be done on the car vs. repairs where the panels have to be removed and refit on the car); and based on the labor costs (of the repairing shop) it might be worth it to repair a damage in one country with cheap labor costs, where in an a more expensive area it might be cheaper to completely replace the part. An example of repair steps and cost estimation 130 is illustrated below in reference to FIG. 3.

FIG. 3 illustrates a graphical user interface 300 for providing repair steps and cost estimation 130, according to certain embodiments. In some embodiments, repair steps and cost estimation 130 includes multiple repair steps 310. Each repair step 310 may include a confidence score 320, a damage type 330, a damage amount 340, and a user-selectable estimate option 350. Confidence score 320 generally indicates how sure visual intelligence engine 120 is about the detected damage (e.g., “97%”). A higher confidence score (i.e., closer to 100%) indicates that intelligence engine 120 is confident about the detected damage. Conversely, a lower confidence score (i.e., closer to 0%) indicates that intelligence engine 120 is not confident about the detected damage. Damage type 330 indicates a type of damage (e.g., “scratch,” “dent,”, “crack,” etc.) and a location of the damage (e.g., “rear bumper”). Damage amount 340 indicates a percentage of damage of the identified part (e.g., “12%”). User-selectable estimate option 350 provides a way for a user to include the selected repair step 310 in repair cost estimate 370. For example, if a particular repair step 310 is selected using its corresponding user-selectable estimate option 350 (e.g., as illustrated for the first four repair steps 310), the item's repair cost will be included in repair cost estimate 370.

In some embodiments, graphical user interface 300 includes a user-selectable option 360 to calculate repair cost estimate 370. For example, a user may select user-selectable option 360 to calculate repair cost estimate 370 based on repair steps 310 whose user-selectable estimate options 350 are selected. In other embodiments, repair cost estimate 370 may be continually and automatically updated based on selections of user-selectable estimate options 350 (i.e., repair cost estimate 370 is calculated when any user-selectable estimate options 350 is selected without waiting for a selection of user-selectable option 360).

Repair cost estimate 370 of graphical user interface 300 provides an overall cost estimate of performing the repair steps 310 whose user-selectable estimate options 350 are selected. In some embodiments, repair cost estimate 370 includes one or more of a parts cost, a labor cost, a paint cost, a grand total (excluding taxes), and a grand total (including taxes). In some embodiments, repair cost estimate 370 may be downloaded or otherwise sent using a user-selectable download option 380.

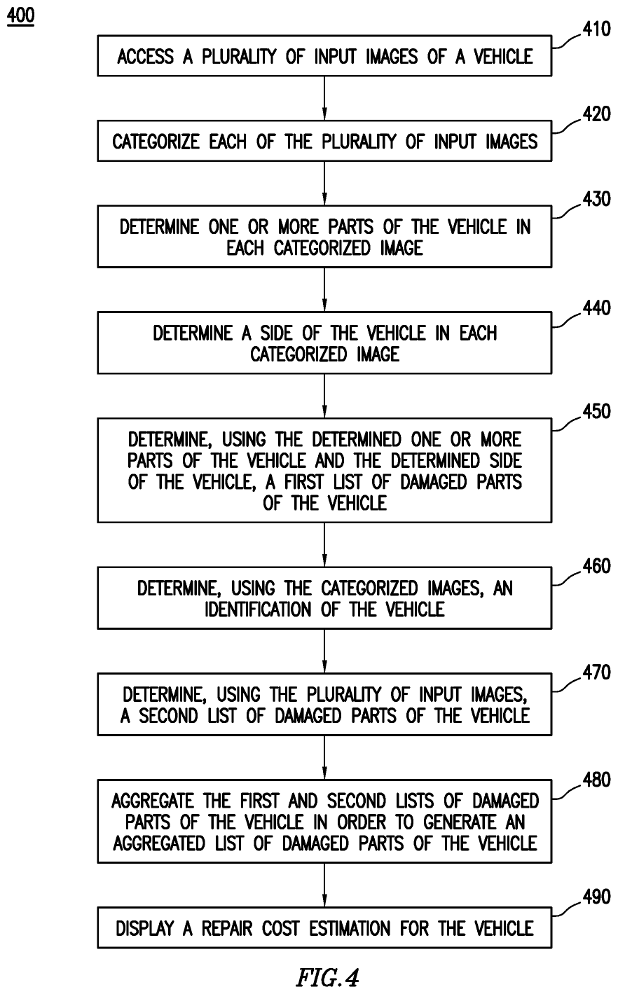

FIG. 4 illustrates a method 400 for providing combined visual intelligence, according to certain embodiments. At step 410, method 400 may access a plurality of input images of a vehicle. As a specific example, one or more images captured by a mobile computing device (e.g., a smartphone) may be accessed. The one or more images may be accessed from the mobile computing device or any other communicatively-coupled storage device (e.g., network storage). In some embodiments, step 410 may be performed by image categorization engine 210.

At step 420, method 400 categorizes each of the plurality of images of step 410 into one of a plurality of categories. In some embodiments, the plurality of categories includes a full-view vehicle image and a close-up vehicle image. In some embodiments, step 410 may be performed by image categorization engine 210.

At step 430, method 400 determines one or more parts of the vehicle in each categorized image from step 420. For example, step 430 may utilize instance segmentation to identify a door, a hood, a fender, or any other appropriate part/area of a vehicle. In some embodiments, step 430 analyzes images from step 420 that have been categorized as a full-view vehicle image or a close-up vehicle image. In some embodiments, step 430 may be performed by object detection engine 220.

At step 440, method 400 determines a side of the vehicle in each categorized image of step 420. In some embodiments, the determined sides may include a front side, a back side, a left side, or a right side of the vehicle. In some embodiments, this step is performed by side detection engine 230.

At step 450, method 400 determines, using the determined one or more parts of the vehicle from step 430 and the determined side of the vehicle from step 440, a first list of damaged parts of the vehicle. In some embodiments, each item in the list of damaged parts may include an item identifier (e.g., door) and the side of the vehicle that the item is located (e.g., front, back, right, left). In some embodiments, this step is performed by damage attribution engine 260.

At step 460, method 400 determines, using the categorized images of step 420, an identification of the vehicle. In some embodiments, this step is performed by model detection engine 240. In some embodiments, this step utilizes multi-image classification to determine the identification of the vehicle. In some embodiments, the identification of the vehicle includes a manufacturer, a model, and a year of the vehicle. In some embodiments, a VIN of the vehicle is used by this step to determine the identification of the vehicle.

At step 470, method 400 determines, using the plurality of input images of step 410, a second list of damaged parts of the vehicle. In some embodiments, this step utilizes multi-image classification to determine the second list of damaged parts of the vehicle. In some embodiments, this step is performed by claim-level classification engine 250.

At step 480, method 400 aggregates, using one or more rules, the first list of damaged parts of the vehicle of step 450 and the second list of damaged parts of the vehicle of step 470 in order to generate an aggregated list of damaged parts of the vehicle. In some embodiments, this step is performed by aggregation engine 270.

At step 490, method 400 displays a repair cost estimation for the vehicle that is determined based on the determined identification of the vehicle of step 460 and the aggregated list of damaged parts of the vehicle of step 480. In some embodiments, this step is performed by aggregation engine 270. In some embodiments, the repair cost estimation is repair steps and cost estimation 130 as illustrated in FIG. 3 and includes a confidence score, a damage type, a damage amount, and a user-selectable estimate option. After step 490, method 400 may end.

The architecture and associated instructions/operations described in this document can provide various advantages over prior approaches, depending on the implementation. For example, this approach provides a detailed blueprint of repairs to a vehicle (e.g., costs, times to repair, etc.) based on one or more images of a vehicle. This may improve the efficiency of providing a vehicle repair estimate by not requiring a human assessor to physically assess a damaged vehicle. Additionally, by automatically providing a repair estimate using images, resources such as paper, electricity, and gasoline may be conserved. Moreover, this functionality can be used to improve other fields of computing, such as artificial intelligence, deep learning, and virtual reality.

In some embodiments, various functions described in this document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “communicate,” “transmit,” and “receive,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

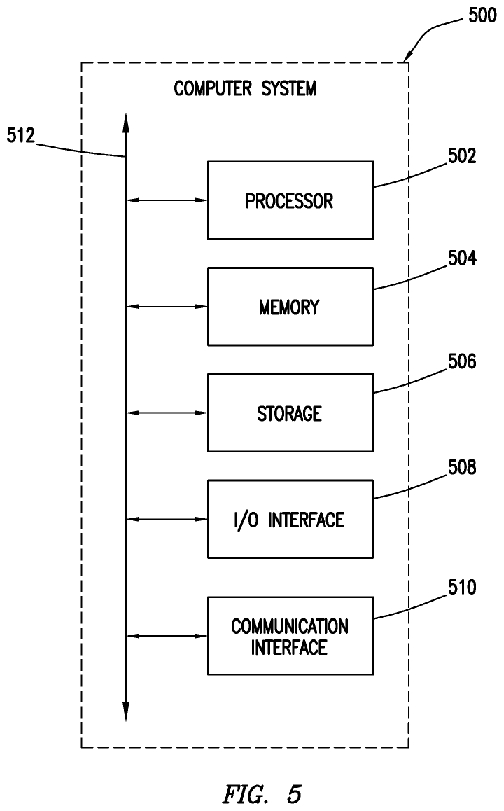

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, “vehicle” encompasses any appropriate means of transportation that user 101 may own and/or use. For example, “vehicle” includes, but is not limited to, any ground-based vehicle such as an automobile, a truck, a motorcycle, an RV, an all-terrain vehicle (ATV), a golf cart, and the like. “Vehicle” also includes, but is not limited to, any water-based vehicle such as a boat, a jet ski, and the like. “Vehicle” also includes, but is not limited to, any air-based vehicle such as an airplane, a helicopter, and the like.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

1. An apparatus comprising:
one or more computer processors; and
one or more memory units communicatively coupled to the one or more computer processors, the one or more memory units comprising instructions executable by the one or more computer processors, the one or more computer processors being operable when executing the instructions to:
access a plurality of input images of a vehicle;
categorize each of the plurality of input images into one of a plurality of categories;
determine one or more parts of the vehicle in each categorized image;
determine a side of the vehicle in each categorized image;
determine, using the determined one or more parts of the vehicle and the determined side of the vehicle, a first list of damaged parts of the vehicle;
determine, using the categorized images, an identification of the vehicle;
determine, using the plurality of input images, a second list of damaged parts of the vehicle;
aggregate, using one or more rules, the first and second lists of damaged parts of the vehicle in order to generate an aggregated list of damaged parts of the vehicle; and
display a repair cost estimation for the vehicle, the repair cost estimation determined based on the determined identification of the vehicle and the aggregated list of damaged parts of the vehicle.

2. The apparatus of claim 1, wherein the plurality of categories comprises:
a full-view vehicle image; and
a close-up vehicle image.

3. The apparatus of claim 1, wherein determining the one or more parts of the vehicle in each categorized image comprises utilizing instance segmentation.

4. The apparatus of claim 1, wherein determining the identification of the vehicle comprises utilizing multi-image classification.

5. The apparatus of claim 1, wherein determining, using the plurality of input images, the second list of damaged parts of the vehicle comprises utilizing multi-image classification.

6. The apparatus of claim 1, wherein the repair cost estimation comprises one or more repair steps, each repair step comprising:
a confidence score;
a damage type;
a damage amount; and
a user-selectable estimate option.

7. The apparatus of claim 1, wherein the vehicle comprises:
an automobile;
a truck;
a recreational vehicle (RV); or
a motorcycle.

8. A method, comprising:
accessing a plurality of input images of a vehicle;
categorizing each of the plurality of input images into one of a plurality of categories;
determining one or more parts of the vehicle in each categorized image;
determining a side of the vehicle in each categorized image;
determining, using the determined one or more parts of the vehicle and the determined side of the vehicle, a first list of damaged parts of the vehicle;
determining, using the categorized images, an identification of the vehicle;
determining, using the plurality of input images, a second list of damaged parts of the vehicle;
aggregating, using one or more rules, the first and second lists of damaged parts of the vehicle in order to generate an aggregated list of damaged parts of the vehicle; and
displaying a repair cost estimation for the vehicle, the repair cost estimation determined based on the determined identification of the vehicle and the aggregated list of damaged parts of the vehicle.

9. The method of claim 8, wherein the plurality of categories comprises:
a full-view vehicle image; and
a close-up vehicle image.

10. The method of claim 8, wherein determining the one or more parts of the vehicle in each categorized image comprises utilizing instance segmentation.

11. The method of claim 8, wherein determining the identification of the vehicle comprises utilizing multi-image classification.

12. The method of claim 8, wherein determining, using the plurality of input images, the second list of damaged parts of the vehicle comprises utilizing multi-image classification.

13. The method of claim 8, wherein the repair cost estimation comprises one or more repair steps, each repair step comprising:
a confidence score;
a damage type;
a damage amount; and
a user-selectable estimate option.

14. The method of claim 8, wherein the vehicle comprises:
an automobile;
a truck;
a recreational vehicle (RV); or
a motorcycle.

15. One or more computer-readable non-transitory storage media embodying one or more units of software that is operable when executed to:
access a plurality of input images of a vehicle;
categorize each of the plurality of input images into one of a plurality of categories;
determine one or more parts of the vehicle in each categorized image;
determine a side of the vehicle in each categorized image;
determine, using the determined one or more parts of the vehicle and the determined side of the vehicle, a first list of damaged parts of the vehicle;
determine, using the categorized images, an identification of the vehicle;
determine, using the plurality of input images, a second list of damaged parts of the vehicle;
aggregate, using one or more rules, the first and second lists of damaged parts of the vehicle in order to generate an aggregated list of damaged parts of the vehicle; and
display a repair cost estimation for the vehicle, the repair cost estimation determined based on the determined identification of the vehicle and the aggregated list of damaged parts of the vehicle.

16. The one or more computer-readable non-transitory storage of claim 15, wherein the plurality of categories comprises:
a full-view vehicle image; and
a close-up vehicle image.

17. The one or more computer-readable non-transitory storage of claim 15, wherein determining the one or more parts of the vehicle in each categorized image comprises utilizing instance segmentation.

18. The one or more computer-readable non-transitory storage of claim 15, wherein determining the identification of the vehicle comprises utilizing multi-image classification.

19. The one or more computer-readable non-transitory storage of claim 15, wherein determining, using the plurality of input images, the second list of damaged parts of the vehicle comprises utilizing multi-image classification.

20. The one or more computer-readable non-transitory storage of claim 15, wherein the repair cost estimation comprises one or more repair steps, each repair step comprising:
a confidence score;
a damage type;
a damage amount; and
a user-selectable estimate option.
